(19) United States
(12) Patent Application Publication
(10) Pub. No.: US 2025/0147715 A1
(43) Pub. Date: May 8, 2025

(54) METHOD OF PLAYING SOUND SOURCE AND COMPUTING DEVICE FOR PERFORMING THE METHOD

(71) Applicant: Electronics and Telecommunications Research Institute, Daejeon (KR)

(72) Inventors: Jae-hyoun YOO, Daejeon (KR); Kyeongok KANG, Daejeon (KR); Yong Ju LEE, Daejeon (KR); Dae Young JANG, Seoul (KR)

(73) Assignee: Electronics and Telecommunications Research Institute, Daejeon (KR)

(21) Appl. No.: 18/794,188

(22) Filed: Aug. 5, 2024

(30) Foreign Application Priority Data
Nov. 3, 2023 (KR) 10-2023-0150850

(51) Int. Cl. G06F 3/16

(52) U.S. Cl. CPC G06F 3/165

(57) ABSTRACT

A method of playing a sound source is provided. The method includes identifying a playback area for at least one higher order ambisonic (HOA) sound source existing in a target space, determining a coordinate calculation standard for playing the HOA sound source based on a positional relationship between the playback area of the HOA sound source and a listener existing in the target space, and calculating a head related transfer function (HRTF) rendering angle of the HOA sound source according to the determined coordinate calculation standard and playing the HOA sound source.

### CROSS-REFERENCE TO RELATED APPLICATION

This application claims the benefit of Korean Patent Application No. 10-2023-0150850, filed on Nov. 3, 2023, in the Korean Intellectual Property Office, the entire disclosure of which is incorporated herein by reference for all purposes.

### BACKGROUND

### 1. Field of the Invention

One or more embodiments relate to a method of playing a sound source and a computing device for performing the method.

### 2. Description of the Related Art

Types of audio signals used in a virtual reality (VR) audio signal processing device with six degrees of freedom (6DoF) include channel signals, object signals, and ambisonic signals.

A channel signal refers to an audio signal in a format where the number of speakers corresponds the number of playback channels, such as traditional mono or stereo, 5.1 channel, 10.2 channel, and 22.2 channel. An object signal refers to an audio signal that individually exists for a specific sound, such as the voice of a singer and a piano sound. An ambisonic signal refers to an audio signal including a plurality of channels such as W, X, Y, and Z in B-format obtained from a spherical harmonic function and is commonly referred to as a higher order ambisonic (HOA) signal, which includes higher order signals.

Moving Picture Experts Group Immersive (MPEG-I), which is currently being standardized, includes a method of providing VR audio using HOA signals and includes multi-point higher order ambisonic (MP-HOA) rendering, which includes multiple HOA signals rather than just one HOA signal in one piece of content, providing greater immersion to a listener.

In addition, MPEG-I defines a coordinate space (cspace) as relative as a coordinate calculation standard for playing HOA signals in a 6DoF environment. cspace is divided into relative and user. Relative is a method of calculating a head related transfer function (HRTF) rendering angle based on a global coordinate system, and user is a method of calculating the HRTF rendering angle in a coordinate system based on the frontal direction in which a listener looks forward.

Since multiple HOA signals are played in an MP-HOA environment, the HOA signals need to be played appropriately according to the position and direction of a listener. In the case of relative, the HRTF rendering angle needs to be continuously corrected according to the position and direction of the listener, and accordingly, there is a disadvantage in that distortion occurs due to computational delay when the listener moves suddenly or turns the head, etc. Therefore, in such an MP-HOA environment, a more effective method of playing HOA signals is required to eliminate the distortion caused by computational delay.

### SUMMARY

Embodiments may provide a method of playing a higher order ambisonic (HOA) signal that may provide a higher sense of immersion to a listener without distortion of a sound field in a multi-point higher order ambisonic (MP-HOA) environment.

However, technical aspects are not limited to the foregoing aspect, and there may be other technical aspects.

According to an aspect, there is provided a method of playing a sound source, the method including identifying a playback area for at least one HOA sound source existing in a target space, determining a coordinate calculation standard for playing the HOA sound source based on a positional relationship between the playback area of the HOA sound source and a listener existing in the target space, and calculating a head related transfer function (HRTF) rendering angle of the HOA sound source according to the determined coordinate calculation standard and playing the HOA sound source.

The determining of the coordinate calculation standard may include, when the listener is located within the playback area of the HOA sound source, determining a reference coordinate system based on a frontal direction in which the listener looks forward as the coordinate calculation standard for playing the HOA sound source.

The determining of the coordinate calculation standard may include, when the listener is located outside the playback area of the HOA sound source, determining a global coordinate system as the coordinate calculation standard for playing the HOA sound source.

The calculating of the HRTF rendering angle and the playing of the HOA sound source may include, when a reference coordinate system based on a frontal direction in which the listener looks forward is determined as the coordinate calculation standard for playing the HOA sound source, playing the HOA sound source in a predetermined direction regardless of movement of the listener.

The calculating of the HRTF rendering angle and the playing of the HOA sound source may include, when a global coordinate system is determined as the coordinate calculation standard for playing the HOA sound source, playing the HOA sound source in different directions according to movement of the listener.

The calculating of the HRTF rendering angle and the playing of the HOA sound source may include, when the global coordinate system is determined as the coordinate calculation standard for playing the HOA sound source, mapping the HOA sound source into a vertical channel and a horizontal channel according to a relative area with respect to the listener and playing the HOA sound source.

According to another aspect, there is provided a method of playing a sound source, the method including, when a listener is located within a playback area of an HOA sound source, calculating an HRTF rendering angle of the HOA sound source according to a first coordinate calculation standard and playing the HOA sound source, and when the listener is located outside the playback area of the HOA sound source, calculating an HRTF rendering angle of the HOA sound source according to a second coordinate calculation standard and playing the HOA sound source, wherein the first coordinate calculation standard and the second coordinate calculation standard include different coordinate systems.

The first coordinate calculation standard may include a reference coordinate system based on a frontal direction in which the listener looks forward.

The second coordinate calculation standard may include a global coordinate system.

According to another aspect, there is provided a computing device including at least one processor and a memory configured to load or store a program executed by the at least one processor, wherein the program may include identifying a playback area for at least one HOA sound source existing in a target space, determining a coordinate calculation standard for playing the HOA sound source based on a positional relationship between the playback area of the HOA sound source and a listener existing in the target space, and calculating an HRTF rendering angle of the HOA sound source according to the determined coordinate calculation standard and playing the HOA sound source.

The processor may be configured to, when the listener is located within the playback area of the HOA sound source, determine a reference coordinate system based on a frontal direction in which the listener looks forward as the coordinate calculation standard for playing the HOA sound source.

The processor may be configured to, when the listener is located outside the playback area of the HOA sound source, determine a global coordinate system as the coordinate calculation standard for playing the HOA sound source.

The processor may be configured to, when a reference coordinate system based on a frontal direction in which the listener looks forward is determined as the coordinate calculation standard for playing the HOA sound source, calculate the HRTF rendering angle of the HOA sound source in a predetermined direction regardless of movement of the listener and playing the HOA sound source.

The processor may be configured to, when a global coordinate system is determined as the coordinate calculation standard for playing the HOA sound source, calculate the HRTF rendering angle of the HOA sound source in different directions according to movement of the listener and playing the HOA sound source.

The processor may be configured to, when the global coordinate system is determined as the coordinate calculation standard for playing the HOA sound source, map the HOA sound source into a vertical channel and a horizontal channel according to a relative area with respect to the listener and play the HOA sound source.

Additional aspects of embodiments will be set forth in part in the description which follows and, in part, will be apparent from the description, or may be learned by practice of the disclosure.

According to embodiments, distortion due to calculation delay may be eliminated by selectively using a coordinate calculation standard for calculating an HRTF rendering angle of an HOA sound source.

According to embodiments, in an MP-HOA environment, a method of playing an HOA signal that may provide a higher sense of immersion to a listener without distortion of a sound field may be provided.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a computing device, according to an embodiment;

FIG. 2 is a flowchart illustrating a method of playing a sound source, according to an embodiment;

FIG. 3 is a diagram illustrating multi-point higher order ambisonic (MP-HOA) content in which a playback area for each of a plurality of higher order ambisonic (HOA) sound sources is set, according to an embodiment; and

FIGS. 4A to 4C are diagrams illustrating a method of playing an HOA sound source according to movement of a listener, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

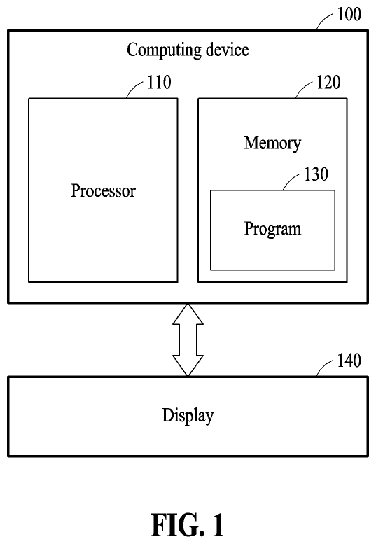

FIG. 1 is a diagram illustrating a configuration of a computing device, according to an embodiment.

Referring to FIG. 1, a computing device 100 may include one or more processors 110 and a memory 120 for loading or storing a program 130 performed by the one or more processors 110. The components included in the computing device 100 of FIG. 1 are just an example, and one of ordinary skill in the art may understand that other generally used components may be further included, besides the components illustrated in FIG. 1.

The one or more processors 110 may control the overall operation of each component of the computing device 100. The one or more processors 110 may include at least one of a central processing unit (CPU), a microprocessor unit (MPU), a microcontroller unit (MCU), a graphics processing unit (GPU), a neural processing unit (NPU), a digital signal processor (DSP), or other well-known types of processors in a relevant field of technology. In addition, the one or more processors 110 may perform an operation of at least one application or program to perform the methods/operations described herein according to embodiments. The computing device 100 may include one or more processors.

The memory 120 may store one of or two or more combinations of various pieces of data, commands, and pieces of information that are used by the components (e.g., the one or more processors 110) included in the computing device 100. The memory 120 may include a volatile memory or a non-volatile memory.

The program 130 may include one or more actions through which the methods/operations described herein according to embodiments are implemented and may be stored in the memory 120 as software. In this case, an operation may correspond to a command that is implemented in the program 130. For example, the program 130 may include instructions that cause the one or more processors 110 to perform identifying a playback area for at least one higher order ambisonic (HOA) sound source existing in a target space, determining a coordinate calculation standard for playing the HOA sound source based on a positional relationship between a playback area of the HOA sound source and a listener existing in the target space, calculating a head related transfer function (HRTF) rendering angle of the HOA sound source according to the determined coordinate calculation standard, and playing the HOA sound source.

When the program 130 is loaded in the memory 120, the one or more processors 110 may execute a plurality of operations to implement the program 130 and perform the methods/operations described herein according to embodiments.

An execution screen of the program 130 may be displayed on a display 140. Although the display 140 is illustrated as being a separate device connected to the computing device 100 in FIG. 1, the display 140 may be included in the components of the computing device 100 when the computing device 100 is a smartphone, a tablet, or other terminals that are portable by a user. The screen displayed on the display 140 may be a state before the information is input to the program 130 or may be an execution result of the program 130.

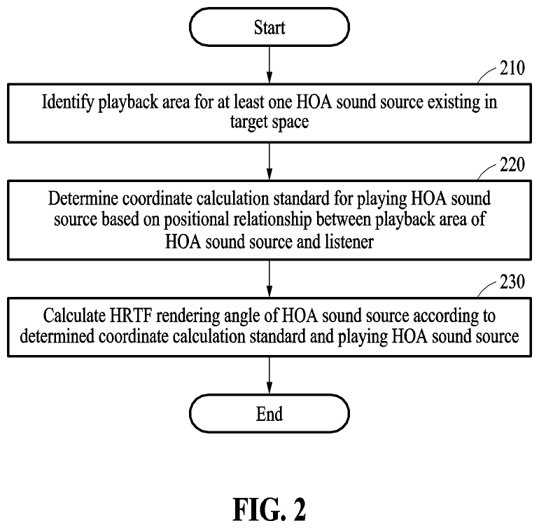

FIG. 2 is a flowchart illustrating a method of playing a sound source, according to an embodiment.

The method of playing a sound source, shown in FIG. 2, may be performed by the processor 110 of the computing device 100 shown in FIG. 1. In operation 210, the processor 110 may identify a playback area for at least one HOA sound source existing in a target space. To this end, the processor 110 may use attribute information called “area” defined in encoder input format (EIF) of Moving Picture Experts Group Immersive (MPEG-I) audio technology, which is being standardized, as shown in Table 1 below.

TABLE 1

| Attribute | Type | Flags | Default | Description |
|---|---|---|---|---|
| area | Value | ◯ | 1 | Radius from the center of |
| | | | | the HOA source(m) |

More specifically, “area” defined in the EIF of MPEG-I audio technology may refer to the radius from the center of the HOA sound source. In other words, “area” is a parameter representing the radius at which the playback area of the HOA sound source is determined from the center of the HOA sound source.

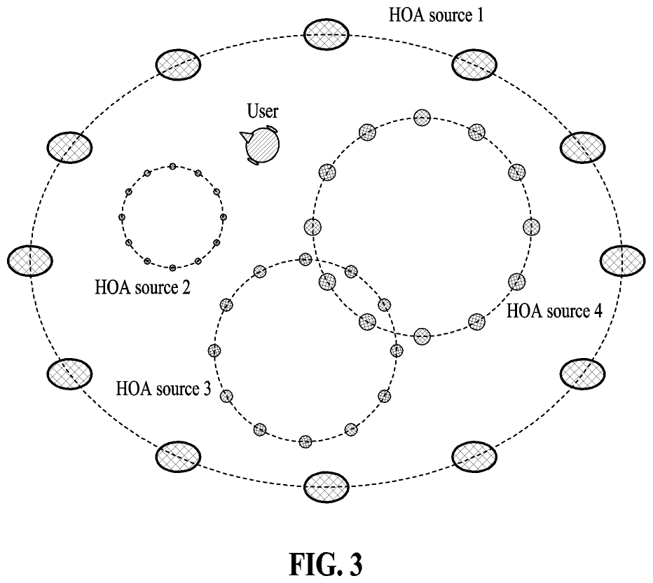

For example, the processor 110 may configure multi-point higher order ambisonic (MP-HOA) content in which the playback area of each of the plurality of HOA sound sources is set as shown in FIG. 3 through the attribute “area” defined in the EIF of MPEG-I audio technology.

Referring to FIG. 3, a listener may freely move within six degrees of freedom (6DoF) virtual reality (VR) content including four HOA sound sources in which playback areas are determined by different centers and radii. Here, according to EIF rules of existing MPEG-I audio technology, since all HOA sound sources are played based on a coordinate space (cspace) corresponding to relative, the processor 110 may need to convert HRTF rendering angles for all HOA sound sources whenever the listener moves.

On the contrary, the processor 110 of the present disclosure may determine a coordinate calculation standard for playing the HOA sound source based on a positional relationship between the playback area of the HOA sound source and the listener, in operation 220.

More specifically, when the listener is located within the playback area of the HOA sound source, the processor 110 may determine a reference coordinate system based on the frontal direction in which the listener looks forward as the coordinate calculation standard for playing the HOA sound source. Here, unlike a global coordinate system in which 0 degrees is fixed, the reference coordinate system may change in real time since the frontal direction in which the listener looks forward is set to 0 degrees so that the frontal direction in which the listener looks forward changes in real time. That is, when the listener is located within the playback area of the HOA sound source, the processor 110 may determine the coordinate calculation standard to play the corresponding HOA sound source based on a coordinate space (cspace) corresponding to user.

On the contrary, when the listener is located outside the playback area of the HOA sound source, the processor 110 may determine a global coordinate system as the coordinate calculation standard for playing the HOA sound source. That is, when the listener is located outside the playback area of the HOA sound source, the processor 110 may determine the coordinate calculation standard to play the corresponding HOA sound source based on a coordinate space (cspace) corresponding to relative.

In operation 230, the processor 110 may calculate an HRTF rendering angle of the HOA sound source according to the determined coordinate calculation standard and playing the HOA sound source. More specifically, when the coordinate calculation standard for playing the HOA sound source is determined based on the reference coordinate system, which is based on the frontal direction in which the listener looks forward, that is, the coordinate space (cspace) corresponding to user, the processor 110 may play the corresponding HOA sound source in the predetermined direction regardless of movement of the listener.

On the contrary, when the coordinate calculation standard for playing the HOA sound source is determined based on the global coordinate system, that is, the coordinate space (cspace) corresponding to relative, the processor 110 may play the corresponding HOA sound source in different directions according to movement of the listener.

Here, HOA sound sources in which the coordinate calculation standard for playing the HOA sound source is determined based on the coordinate space (cspace) corresponding to relative may be mapped to two-dimensional channels including vertical channels and horizontal channels according to a relative area with respect to the listener and may be played as an extent sound source. Here, the extent sound source refers to a sound source having a line, surface, or volume, rather than a point sound source. Depending on the positional relationship with the listener, the HOA sound sources may be played as a sound source having a line, surface, or volume. Here, the two-dimensional channels may include L and R channels corresponding to the outer left and right sides or L, C, and R channels including a central sound image, and height channels including TL, T, and TR channels, which are top channels, and BL, B, BR channels, which are bottom channels.

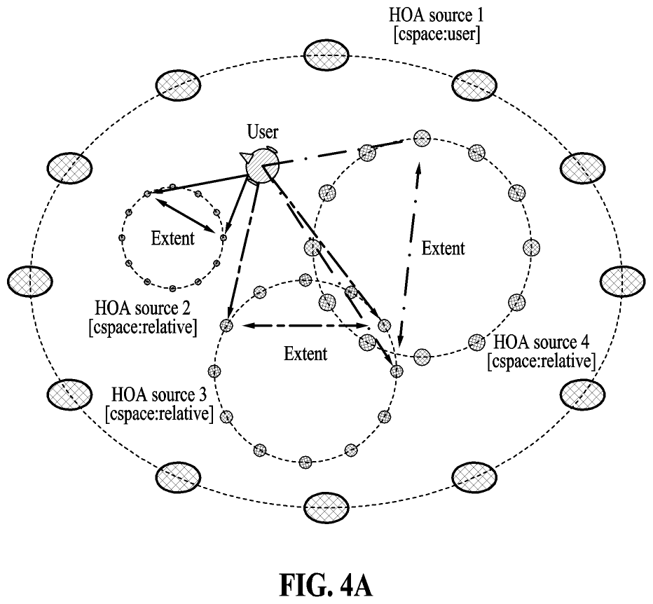

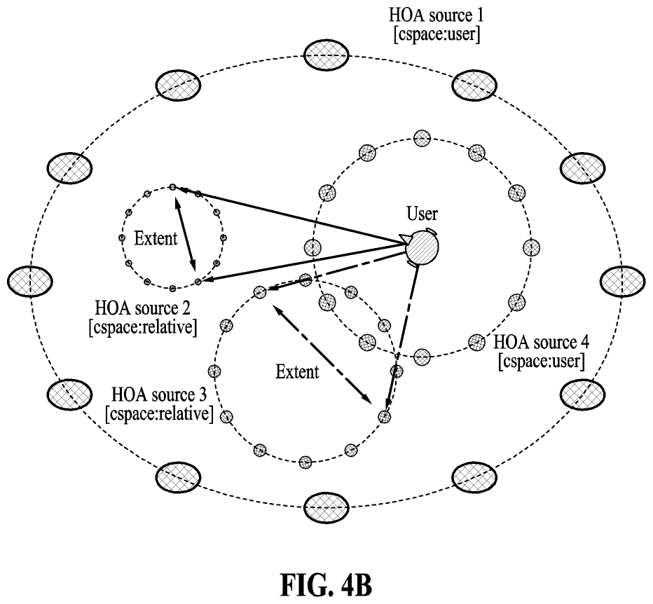

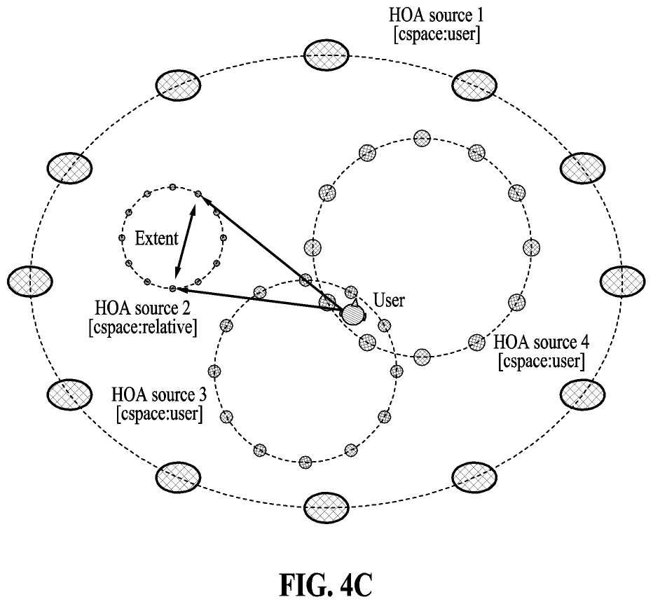

FIGS. 4A to 4C are diagrams illustrating a method of playing an HOA sound source according to movement of a listener, according to an embodiment.

Referring to FIG. 4A, a listener is located within a playback area of a first HOA sound source (HOA source 1) and outside playback areas of the remaining HOA sound sources. In this case, the processor 110 may determine a coordinate calculation standard to play the first HOA sound source (HOA source 1) based on a coordinate space (cspace) corresponding to user. Subsequently, the processor 110 may play the first HOA sound source (HOA source 1) in the predetermined direction regardless of movement of the listener according to the determined coordinate calculation standard.

On the contrary, the processor 110 may determine the coordinate calculation standard to play the remaining HOA sound sources based on the coordinate space (cspace) corresponding to relative. Subsequently, the processor 110 may play the remaining HOA sound sources as extent sound sources in different directions according to the movement of the listener according to the determined coordinate calculation standard.

Referring to FIG. 4B, as the listener moves into a playback area of a fourth HOA sound source (HOA source 4), the listener is located within the playback area of the first HOA sound source (HOA source 1) and the playback area of the fourth HOA sound source (HOA source 4) and outside the playback areas of the remaining HOA sound sources.

In this case, the processor 110 may determine the coordinate calculation standard to play the first HOA sound source (HOA source 1) and the fourth HOA sound source (HOA source 4) based on the coordinate space (cspace) corresponding to user. Subsequently, the processor 110 may play the first HOA sound source (HOA source 1) and the fourth HOA sound source (HOA source 4) in the predetermined direction regardless of the movement of the listener according to the determined coordinate calculation standard.

On the contrary, the processor 110 may determine the coordinate calculation standard to play the remaining HOA sound sources based on the coordinate space (cspace) corresponding to relative. Subsequently, the processor 110 may play the remaining HOA sound sources as extent sound sources in different directions according to the movement of the listener according to the determined coordinate calculation standard.

Referring to FIG. 4C, as the listener moves into an overlapping area of a playback area of a third HOA sound source (HOA source 3) and the playback area of the fourth HOA sound source (HOA source 4), the listener is located within the playback area of the first HOA sound source (HOA source 1), the playback area of the third HOA sound source (HOA source 3), and the playback area of the fourth HOA sound source (HOA source 4) and outside a playback area of the remaining second HOA sound source (HOA source 2).

In this case, the processor 110 may determine the coordinate calculation standard to play the first HOA sound source (HOA source 1), the third HOA sound source (HOA source 3), and the fourth HOA sound source (HOA source 4) based on the coordinate space (cspace) corresponding to user. Subsequently, the processor 110 may play the first HOA sound source (HOA source 1), the third HOA sound source (HOA source 3), and the fourth HOA sound source (HOA source 4) in the predetermined direction regardless of the movement of the listener according to the determined coordinate calculation standard.

On the contrary, the processor 110 may determine the coordinate calculation standard to play the remaining second HOA sound source (HOA source 2) based on the coordinate space (cspace) corresponding to relative. Subsequently, the processor 110 may play the remaining second HOA sound source (HOA source 2) as extent sound sources in different directions according to the movement of the listener according to the determined coordinate calculation standard.

In such a method, the processor 110 may play the HOA sound source in the MP-HOA environment by flexibly selecting the coordinate calculation standard according to the positional relationship between the listener and the HOA sound source, thereby playing stable HOA sound source without distortion of a sound field even if the listener moves suddenly or turns the head, etc.

The components described in the embodiments may be implemented by hardware components including, for example, at least one DSP, a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method of playing a sound source, the method comprising:
identifying a playback area for at least one higher order ambisonic (HOA) sound source existing in a target space;
determining a coordinate calculation standard for playing the HOA sound source based on a positional relationship between the playback area of the HOA sound source and a listener existing in the target space; and
calculating a head related transfer function (HRTF) rendering angle of the HOA sound source according to the determined coordinate calculation standard and playing the HOA sound source.

2. The method of claim 1, wherein
the determining of the coordinate calculation standard comprises, when the listener is located within the playback area of the HOA sound source, determining a reference coordinate system based on a frontal direction in which the listener looks forward as the coordinate calculation standard for playing the HOA sound source.

3. The method of claim 1, wherein
the determining of the coordinate calculation standard comprises, when the listener is located outside the playback area of the HOA sound source, determining a global coordinate system as the coordinate calculation standard for playing the HOA sound source.

4. The method of claim 1, wherein
the calculating of the HRTF rendering angle and the playing of the HOA sound source comprise, when a reference coordinate system based on a frontal direction in which the listener looks forward is determined as the coordinate calculation standard for playing the HOA sound source, playing the HOA sound source in a predetermined direction regardless of movement of the listener.

5. The method of claim 1, wherein
the calculating of the HRTF rendering angle and the playing of the HOA sound source comprise, when a global coordinate system is determined as the coordinate calculation standard for playing the HOA sound source, playing the HOA sound source in different directions according to movement of the listener.

6. The method of claim 5, wherein
the calculating of the HRTF rendering angle and the playing of the HOA sound source comprise, when the global coordinate system is determined as the coordinate calculation standard for playing the HOA sound source, mapping the HOA sound source into a vertical channel and a horizontal channel according to a relative area with respect to the listener and playing the HOA sound source.

7. A method of playing a sound source, the method comprising:
when a listener is located within a playback area of a higher order ambisonic (HOA) sound source, calculating a head related transfer function (HRTF) rendering angle of the HOA sound source according to a first coordinate calculation standard and playing the HOA sound source; and
when the listener is located outside the playback area of the HOA sound source, calculating an HRTF rendering angle of the HOA sound source according to a second coordinate calculation standard and playing the HOA sound source,
wherein the first coordinate calculation standard and the second coordinate calculation standard include different coordinate systems.

8. The method of claim 7, wherein
the first coordinate calculation standard includes a reference coordinate system based on a frontal direction in which the listener looks forward.

9. The method of claim 7, wherein
the second coordinate calculation standard includes a global coordinate system.

10. A non-transitory computer-readable storage medium storing instructions that, when executed by a processor, cause the processor to perform the method of claim 1.

11. A computing device comprising:
at least one processor; and
a memory configured to load or store a program executed by the at least one processor,
wherein the program comprises:
identifying a playback area for at least one higher order ambisonic (HOA) sound source existing in a target space;
determining a coordinate calculation standard for playing the HOA sound source based on a positional relationship between the playback area of the HOA sound source and a listener existing in the target space; and
calculating a head related transfer function (HRTF) rendering angle of the HOA sound source according to the determined coordinate calculation standard and playing the HOA sound source.

12. The computing device of claim 11, wherein
the processor is configured to, when the listener is located within the playback area of the HOA sound source, determine a reference coordinate system based on a frontal direction in which the listener looks forward as the coordinate calculation standard for playing the HOA sound source.

13. The computing device of claim 11, wherein
the processor is configured to, when the listener is located outside the playback area of the HOA sound source, determine a global coordinate system as the coordinate calculation standard for playing the HOA sound source.

14. The computing device of claim 11, wherein
the processor is configured to, when a reference coordinate system based on a frontal direction in which the listener looks forward is determined as the coordinate calculation standard for playing the HOA sound source, calculate the HRTF rendering angle of the HOA sound source in a predetermined direction regardless of movement of the listener and playing the HOA sound source.

15. The computing device of claim 11, wherein
the processor is configured to, when a global coordinate system is determined as the coordinate calculation standard for playing the HOA sound source, calculate the HRTF rendering angle of the HOA sound source in different directions according to movement of the listener and playing the HOA sound source.

16. The computing device of claim 15, wherein
the processor is configured to, when the global coordinate system is determined as the coordinate calculation standard for playing the HOA sound source, map the HOA sound source into a vertical channel and a horizontal channel according to a relative area with respect to the listener and play the HOA sound source.
